(19) United States
(12) Patent Application Publication
(10) Pub. No.: US 2021/0048792 A1
(43) Pub. Date: Feb. 18, 2021

(54) DIAGNOSTIC APPARATUS, SYSTEM, DIAGNOSTIC METHOD, AND PROGRAM

(71) Applicant: NEC Corporation, Minato-ku, Tokyo (JP)

(72) Inventors: Yasuharu ONISHI, Tokyo (JP); Yasuyuki FUKUTA, Tokyo (JP); Takashi KUDO, Tokyo (JP)

(73) Assignee: NEC Corporation, Minato-ku, Tokyo (JP)

(21) Appl. No.: 16/969,335

(22) PCT Filed: Sep. 6, 2018
(86) PCT No.: PCT/JP2018/032974

§ 371 Date: Aug. 12, 2020

(30) Foreign Application Priority Data
Mar. 5, 2018 (JP) 2018-038388

(51) Int. Cl. G05B 19/406; G01M 13/00

(52) U.S. Cl. CPC G05B 19/406; G05B 2219/37634; G01M 13/00

(57) ABSTRACT

A diagnostic apparatus includes an acquisition part, an FFT part, and a determination part. The acquisition part acquires vibration data outputted by a sensor. The FFT part generates an initial waveform from the vibration data acquired when the production equipment is operated without load at installation thereof. The FFT part generates a start-up waveform from the vibration data acquired when the production equipment is operated without load. The FFT part generates an operation waveform from the vibration data acquired when the production equipment is operated with load. The determination part determines whether the production equipment has performed its production normally, based on the start-up waveform and the operation waveform. The determination part corrects a threshold(s) used for determining whether the production has been performed normally, based on the initial waveform and the start-up waveform.

### REFERENCE TO RELATED APPLICATION

The present invention is based upon and claims the benefit of the priority of Japanese patent application No. 2018-038388, filed on Mar. 5, 2018, the disclosure of which is incorporated herein in its entirety by reference thereto.

The present invention relates to a diagnostic apparatus, a system, a diagnostic method, and a program.

### BACKGROUND

### Field

Production equipment (a production apparatus) having a rotation mechanism such as a motor is used for a cutting process on metal or the like. When such production equipment having the rotation mechanism is operated, the motor rotates and vibration occurs.

There are various techniques that use the vibration, which is caused when production equipment is operated, for abnormality sensing or the like. For example, as a method for determining a malfunction of an apparatus of production equipment or an abnormality of a product in real time, there is a method that uses sensed data such as vibration or the like.

Specifically, normal data obtained when production equipment has performed a process normally and abnormal data obtained when the production equipment has not performed the process normally are collected and analyzed, and a threshold for distinguishing a normal process state from an abnormal process state is calculated. Thereafter, fast Fourier transform (FFT) is performed on vibration data obtained when the production equipment is operated. Next, abnormality sensing is performed by performing threshold processing or the like in the frequency domain on the resultant data.

PTL 1 discloses a vibration diagnosis apparatus having a function of storing vibration signals measured online when an operation is performed as history data and reproducing the vibration signals when necessary.

PTL 2 discloses an abnormality sensing apparatus that detects an acoustic signal generated from an individual apparatus in a plant including a plurality of apparatuses and automatically senses an abnormality of an individual apparatus. PTL 2 discusses improving the sensing accuracy by preventing the background noise of the plant from drowning out the acoustic signals of the individual apparatuses.

### CITATION LIST

### Patent Literature

PTL 1: Japanese Patent Kokai Publication No. JP-H02-159525A

PTL 2: Japanese Patent Kokai Publication No. JP-H04-258721A

### SUMMARY

### Technical Problem

The disclosure of each of the above PTLs is incorporated herein by reference thereto. The following analysis has been made by the present inventors.

As described above, vibration data obtained when production equipment is operated has been used for sensing abnormalities of the production equipment and production materials.

Many items of information are included in signals obtained from a vibration sensor attached to the production equipment or the like. Specifically, examples of the information include the vibration obtained when the motor rotates axially, the vibration caused when a chassis resonates due to the rotation of the motor, and the vibration (the vibration based on a process) caused when a tool such as a drill blade comes into contact with a production material (a material to be processed). In addition, environmental noise (for example, the vibration caused when different equipment is operated) could be included in the information obtained from the vibration sensor.

Among these items of information, information that is valuable in terms of determining the process state is the vibration caused when a tool comes into contact with a production material. For example, a waveform illustrated in FIG. 22A is a power spectrum obtained when a production material is being processed normally. In contrast, waveforms illustrated in FIGS. 22B and 22C are power spectra, each of which is obtained when a production material is not being processed normally, namely, when a production material is being processed abnormally.

When the waveforms in FIGS. 22A and 22B are compared with each other, it is seen that the waveforms have different peak frequencies Fm and Fm′, respectively. In addition, when the waveforms in FIGS. 22A and 22C are compared with each other, it is seen that the waveforms spread differently. To determine the process state, for example, thresholds for determining whether the process has been performed normally are determined, based on the waveforms illustrated in FIGS. 22A to 22C. For example, a threshold for determining the deviation of the frequency and a threshold for determining the spread of the frequency component are calculated.

As described above, among the information obtained from the vibration sensor, what is truly needed for determining the process state is information about the vibration caused by the process. In other words, it is desirable that the waveform (a power spectrum) used for determining the process does not include information other than the information about the vibration caused by the process. For example, even if the determination processing (threshold processing) is performed on a power spectrum including environmental noise, the impact of the environmental noise could cause an erroneous determination. For example, as illustrated in FIG. 22D, even if the process has been performed normally, if environmental noise (a waveform indicated by light gray) is superposed, the spread of the frequency component near the peak frequency could be determined to be large, and as a result, “abnormal process” could be determined.

In addition, if production equipment has deteriorated with age, a threshold set at the time of installation of the equipment could not be suitable for the latest power spectrum obtained from the production equipment. Namely, the rotation frequency of a motor of production equipment changes due to mechanical friction. If the rotation frequency of the motor changes, the vibration (frequency) caused by the process also changes. Thus, even if the process has been performed normally, if a threshold determined based on a power spectrum obtained when the production equipment is initially installed is used, “abnormal process state” could be determined.

For example, as illustrated in FIG. 22E, if the rotation frequency of the motor deviates by AF, the frequency of the vibration caused when the process is performed also deviates by AF. In FIG. 22E, the waveforms indicated by dotted lines represent the number of rotations of the motor when the production equipment is initially installed (a peak on the left side) and the vibration caused by the process (a peak on the right side). In addition, the waveforms indicated by solid lines represent the number of rotations of the motor at the moment (deteriorated with age) (a peak on the left side) and the vibration caused by the process (a peak on the right side).

As is clear from FIG. 22E, when the production equipment is deteriorated with age, the frequency of the vibration at the time of the process is deviated. Thus, an accurate result cannot be obtained unless the determination is made in consideration of the deviation of the frequency.

It is a primary object of the present invention to provide a diagnostic apparatus, a system, a diagnostic method, and a program that contribute to accurately determining whether a process has been performed normally by production equipment.

### Solution to Problem

According to the present invention or a first aspect disclosed, there is provided a diagnostic apparatus, including: an acquisition part that acquires vibration data outputted by a sensor that detects vibration caused by production equipment having a rotation mechanism; a fast Fourier transform (FFT) part that stores, as an initial waveform, a frequency spectrum calculated from the vibration data acquired when the production equipment is operated without load at installation thereof, stores, as a start-up waveform, a frequency spectrum calculated from the vibration data acquired when the production equipment is operated without load, and stores, as an operation waveform, a frequency spectrum calculated from the vibration data acquired when the production equipment is operated with load; and a determination part that determines whether the production equipment has processed production material normally, based on the start-up waveform and the operation waveform; wherein the determination part corrects a threshold(s) used for determining whether the production material has been processed normally, based on the initial waveform and the start-up waveform.

According to the present invention or a second aspect disclosed, there is provided a system, including: production equipment having a rotation mechanism; a sensor(s) that detects vibration caused by the production equipment; and a diagnostic apparatus; wherein the diagnostic apparatus includes: an acquisition part that acquires vibration data outputted by the sensor(s); a fast Fourier transform (FFT) part that stores, as an initial waveform, a frequency spectrum calculated from the vibration data acquired when the production equipment is operated without load at installation thereof, stores, as a start-up waveform, a frequency spectrum calculated from the vibration data acquired when the production equipment is operated without load, and stores, as an operation waveform, a frequency spectrum calculated from the vibration data acquired when the production equipment is operated with load; and a determination part that determines whether the production equipment has processed production material normally, based on the start-up waveform and the operation waveform; wherein the determination part corrects a threshold(s) used for determining whether the production material has been processed normally, based on the initial waveform and the start-up waveform.

According to the present invention or a third aspect disclosed, there is provided a diagnostic method, including: causing a diagnostic apparatus, which includes an acquisition part that acquires vibration data outputted by a sensor that detects vibration caused by production equipment having a rotation mechanism and a fast Fourier transform (FFT) part that stores, as an initial waveform, a frequency spectrum calculated from the vibration data acquired when the production equipment is operated without load at installation thereof, stores, as a start-up waveform, a frequency spectrum calculated from the vibration data acquired when the production equipment is operated without load, and stores, as an operation waveform, a frequency spectrum calculated from the vibration data acquired when the production equipment is operated with load, to correct a threshold(s) used for determining whether production material has been processed normally, based on the initial waveform and the start-up waveform; and causing the diagnostic apparatus to determine whether the production equipment has processed the production material normally, based on the corrected threshold(s), the start-up waveform, and the operation waveform.

According to the present invention or a fourth aspect disclosed, there is provided a program, causing a computer mounted on a diagnostic apparatus, which includes an acquisition part that acquires vibration data outputted by a sensor that detects vibration caused by production equipment having a rotation mechanism and a fast Fourier transform (FFT) part that stores, as an initial waveform, a frequency spectrum calculated from the vibration data acquired when the production equipment is operated without load at installation thereof, stores, as a start-up waveform, a frequency spectrum calculated from the vibration data acquired when the production equipment is operated without load, and stores, as an operation waveform, a frequency spectrum calculated from the vibration data acquired when the production equipment is operated with load, to perform processing for: correcting a threshold(s) used for determining whether production material has been processed normally, based on the initial waveform and the start-up waveform; and determining whether the production equipment has processed the production material normally, based on the corrected threshold(s), the start-up waveform, and the operation waveform. This program can be recorded in a computer-readable storage medium. The storage medium may be a non-transient storage medium such as a semiconductor memory, a hard disk drive, a magnetic recording medium, or an optical recording medium. The present invention can also be embodied as a computer program product.

### Advantageous Effects of Invention

According to the present invention or the aspects disclosed, there are provided a diagnostic apparatus, a system, a diagnostic method, and a program that contribute to accurately determining whether a process has been performed normally by production equipment.

### BRIEF DESCRIPTION OF THE DRAWINGS

FIG. 1 illustrates an outline of an exemplary embodiment.

FIG. 2 illustrates an example of a production system according to a first exemplary embodiment.

FIG. 3 illustrates an example of an initial waveform.

FIG. 4 illustrates an example of an initial operation waveform.

FIG. 5 illustrates an example of a start-up waveform.

FIG. 6 illustrates an example of an operation waveform.

FIG. 7 illustrates an example of a state transition of a diagnostic apparatus according to the first exemplary embodiment.

FIG. 8 illustrates a display example outputted by the diagnostic apparatus according to the first exemplary embodiment.

FIG. 9 illustrates a hardware example of the diagnostic apparatus according to the first exemplary embodiment.

FIG. 10 illustrates an example of a processing configuration of the diagnostic apparatus according to the first exemplary embodiment.

FIG. 11 is a flowchart illustrating an example of an operation of a threshold generation part.

FIG. 12 illustrates an example of a power spectrum generated by a threshold generation part.

FIGS. 13A-13B illustrate an example of another power spectrum generated by the threshold generation part.

FIG. 14 is a flowchart illustrating an example of an operation of a determination part.

FIG. 15 is a flowchart illustrating an example of a process determination operation by the determination part.

FIG. 16 illustrates an example of a result obtained by subtracting the start-up waveform from the operation waveform.

FIG. 17 illustrates an example of a production system according to a second exemplary embodiment.

FIG. 18 illustrates a difference between a vibration sensor and an acoustic sensor.

FIG. 19 illustrates an example of a production system according to a third exemplary embodiment.

FIGS. 20A-20B illustrate an example of an initial operation waveform.

FIGS. 21A-21B illustrate an example of an operation waveform.

FIGS. 22A-22E illustrate examples of power spectra obtained from a vibration sensor.

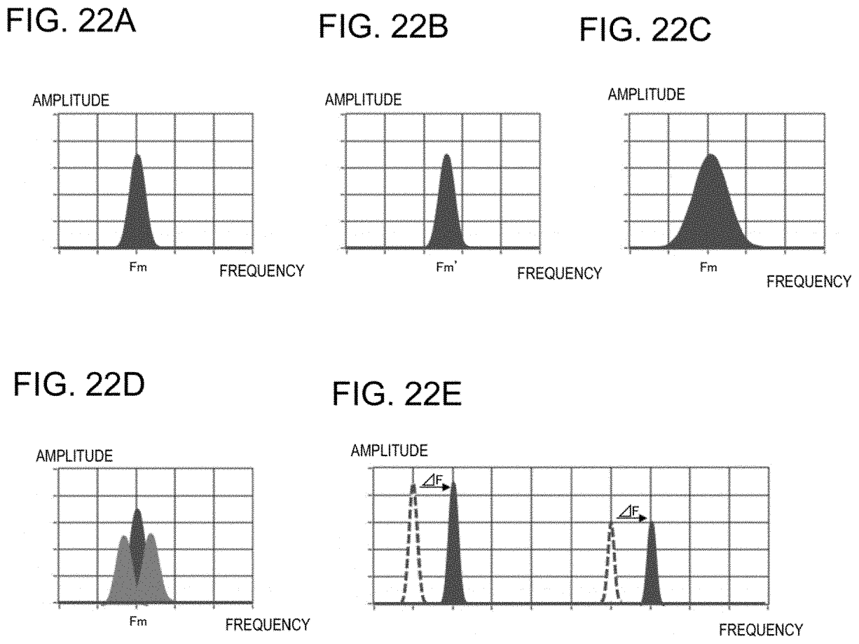

### MODES

First, an outline of an exemplary embodiment will be described. Reference characters in the following outline denote various elements for the sake of convenience and are used as examples to facilitate understanding of the present invention. Namely, the description of the outline is not intended to indicate any limitations. An individual connection line between blocks in an individual drawing signifies both one-way and two-way directions. An arrow schematically illustrates a principal signal (data) flow and does not exclude bidirectionality. While not explicitly illustrated in the circuit diagrams, the block diagrams, the internal configuration diagrams, the connection diagrams, etc. in the disclosure of the present application, an input port and an output port exist at an input end and an output end of an individual connection line. The same holds true for the input-output interfaces.

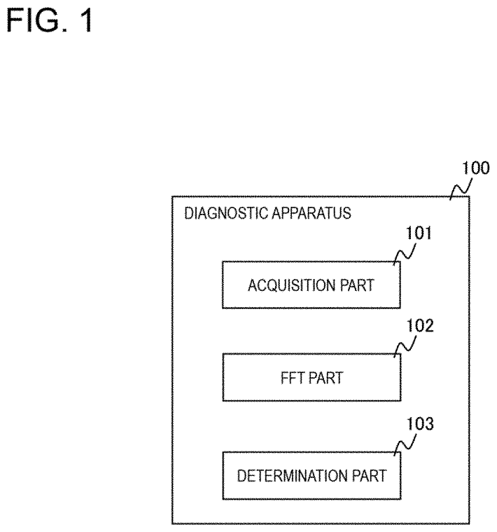

A diagnostic apparatus 100 according to an exemplary embodiment includes an acquisition part 101, a fast Fourier transform (FFT) part 102, and a determination part 103 (see FIG. 1). The acquisition part 101 acquires vibration data outputted by a sensor that detects vibration caused by production equipment having a rotation mechanism. The FFT part 102 stores, as an initial waveform, a frequency spectrum calculated from the vibration data acquired when the production equipment is operated without load at installation thereof. In addition, the FFT part 102 stores, as a start-up waveform, a frequency spectrum calculated from the vibration data acquired when the production equipment is operated without load. In addition, the FFT part 102 stores, as an operation waveform, a frequency spectrum calculated from the vibration data acquired when the production equipment is operated with load. The determination part 103 determines whether the production material has been processed normally by the production equipment based on the start-up waveform and the operation waveform. In addition, the determination part 103 corrects a threshold(s) used for determining whether the production material has been processed normally based on the initial waveform and the start-up waveform.

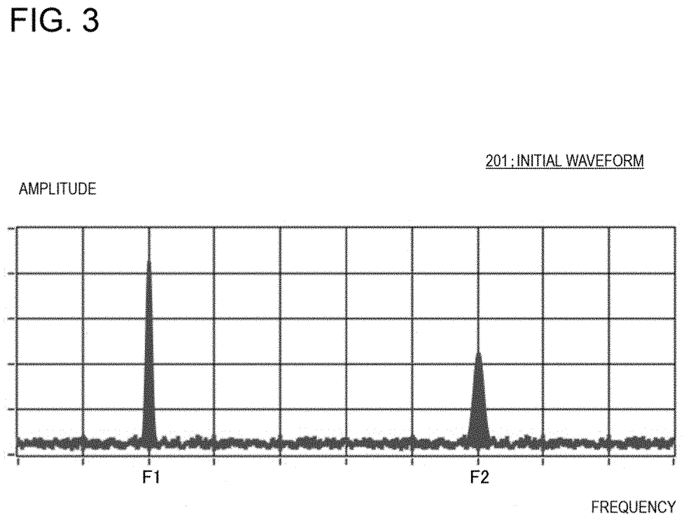

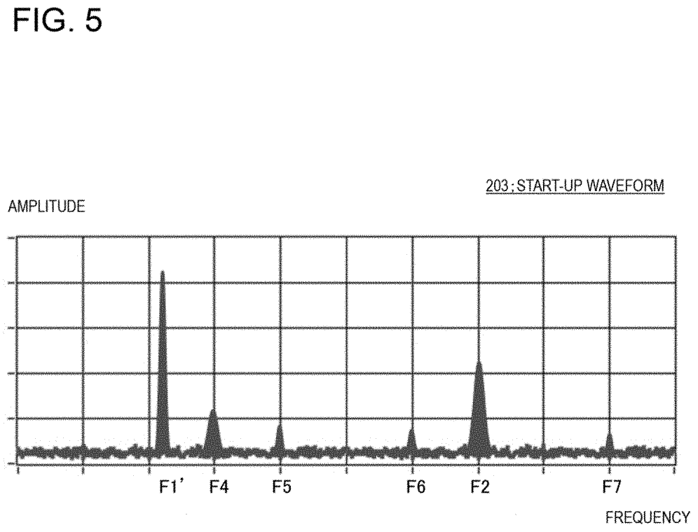

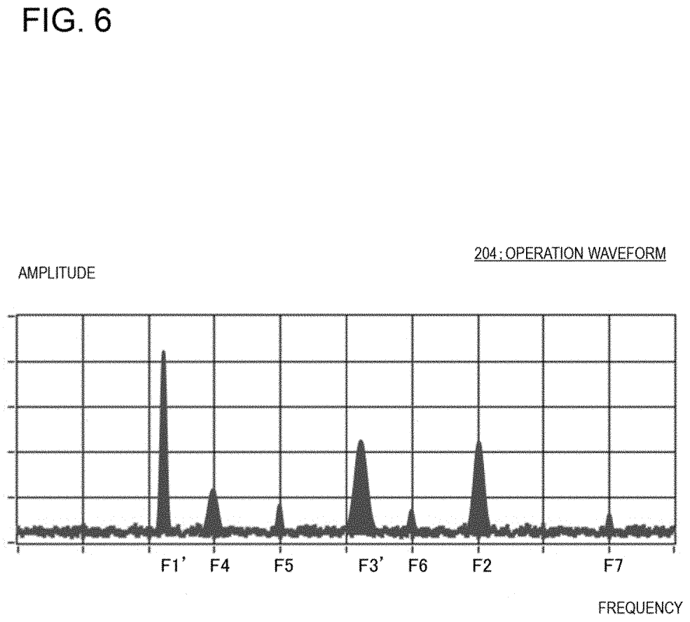

When the production equipment is installed at a factory or the like for the first time, the diagnostic apparatus 100 operates the production equipment on which material to be processed is not set (without load) and generates an initial waveform (an initial waveform 201 illustrated in FIG. 3, for example). In addition, immediately before causing the production equipment to start the process, the diagnostic apparatus 100 operates the production equipment without load and generates a start-up waveform (a start-up waveform 203 illustrated in FIG. 5, for example). In addition, the diagnostic apparatus 100 generates a waveform (an operation waveform 204 illustrated in FIG. 6) indicating an actual process performed by the production equipment.

The diagnostic apparatus 100 determines whether the production equipment has performed the process normally by using these waveforms. Specifically, by subtracting the start-up waveform from the operation waveform, the diagnostic apparatus 100 removes environmental noise. Next, the diagnostic apparatus 100 determines whether the production equipment has performed the process normally by performing threshold processing or the like on the resultant waveform from which the environmental noise has been removed.

While a threshold changes as the rotation mechanism (a motor or the like) of the production equipment deteriorates with age, the diagnostic apparatus 100 corrects the threshold based on the initial waveform and the start-up waveform. Specifically, if a peak frequency of the initial waveform and a peak frequency of the start-up waveform are deviated from each other by more than a predetermined value, the diagnostic apparatus 100 determines that the rotation mechanism has deteriorated with age and reflects this deviation of the peak frequency on the threshold (adds the deviation to the threshold).

As described above, the diagnostic apparatus 100 determines whether the production material has been processed normally while removing the environmental noise caused at the time of production and correcting mismatch of the threshold caused by age deterioration of the rotation mechanism. As a result, the diagnostic apparatus 100 can accurately determine whether the production equipment has performed the process normally.

Hereinafter, specific exemplary embodiments will be described in more detail with reference to drawings. In the exemplary embodiments, like elements are denoted by like reference characters, and description thereof will be omitted.

### First Exemplary Embodiment

A first exemplary embodiment will be described in more detail with reference to drawings.

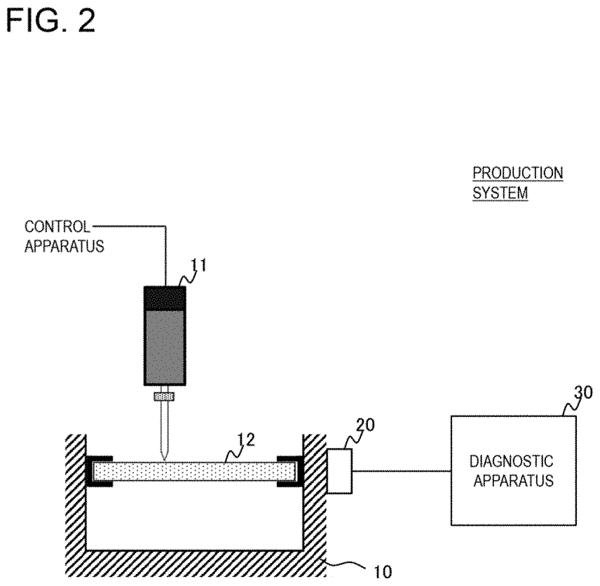

FIG. 2 illustrates an example of a production system according to the first exemplary embodiment. As illustrated in FIG. 2, the production system includes production equipment 10, a vibration sensor 20, and a diagnostic apparatus 30.

The production equipment 10 is an apparatus that includes a motor 11 as a rotation mechanism. In practice, the production equipment 10 includes an actuator, a power supply, etc. for moving the motor 11 and a production material 12. However, illustration of these elements is omitted in FIG. 2.

The motor 11 is connected to a control apparatus, and control processing relating to a process of the production material 12 is performed. For example, FIG. 2 illustrates an example in which a hole is made in the production material 12 by a drill blade attached to the motor 11. The production system illustrated in FIG. 2 is an example, and the process is not limited to “drilling a hole”. The production equipment 10 may perform a turning process, milling process, or the like.

The vibration sensor 20 is a sensor for detecting vibration. For example, the vibration sensor 20 is installed beside a clamp that holds the production material 12. The vibration sensor 20 converts a physical amount relating to displacement, acceleration, velocity, or the like at the installation location into an electrical signal and outputs the electrical signal.

Any kind (type) of sensor may be used as the vibration sensor 20. Any vibration sensor that can detect vibration in at least one axis direction in a three-dimensional coordinate system may be used as the vibration sensor 20. The vibration sensor 20 is connected to the diagnostic apparatus 30.

The diagnostic apparatus determines whether the production material 12 has been processed normally by using the output (vibration data) from the vibration sensor 20. Hereinafter, the determination of whether the production material 12 has been processed normally will be referred to as “process determination”.

First, a general operation of the production system according to the first exemplary embodiment will be described with reference to FIG. 2.

The production system has three operation modes, which are an initial mode, a test mode, and a normal mode.

The initial mode is a mode performed when the production equipment 10 is installed at a factory or the like for the first time. Specifically, the initial mode is performed when new production equipment 10 whose parts such as the motor 11 have not deteriorated with age is installed at a factory for the first time.

In the initial mode, the new production equipment 10 is operated with as little environmental noise as possible, for example. More specifically, by stopping operations of different apparatuses at the factory or the like other than the production equipment 10, the user creates a situation in which the production equipment 10 is not affected by the vibrations of these different apparatuses. Next, by operating the control apparatus, the user operates the production equipment 10 (rotates the motor 11) to which the production material 12 is not attached. For example, the user operates the production equipment 10 with a predetermined initial rotation number for a predetermined time (for example, 30 seconds in consideration of reproducibility). Next, the user increases the rotation number with a predetermined slope.

The diagnostic apparatus 30 in the initial mode acquires vibration data that occurs due to the operation from the vibration sensor 20, performs FFT processing on the acquired vibration data, and generates a power spectrum (a frequency spectrum). The diagnostic apparatus 30 stores and holds the generated power spectrum as “an initial waveform”.

As described above, in the production system, the production equipment 10 is operated without environmental noise and without load, namely, without the production material 12 being processed, and a power spectrum that represents characteristics of the vibration caused by the operation is generated (a power spectrum that represents characteristics of the vibration as information). For example, a power spectrum as illustrated in FIG. 3 is generated and stored as the initial waveform 201.

While the individual power spectra illustrated in the disclosure of the present application have been simplified to facilitate the understanding of the present invention, harmonics, etc. of the rotation frequency of the motor 11 are also included in practice.

Next, by operating the control apparatus, the user operates the production equipment 10 (rotates the motor 11) to which the production material 12 is attached, to actually process the production material 12.

The diagnostic apparatus 30 acquires the vibration data caused by the operation from the vibration sensor 20 and performs FFT processing on the acquired vibration data, to generate a power spectrum. The diagnostic apparatus 30 stores and holds the generated power spectrum as “an initial operation waveform”.

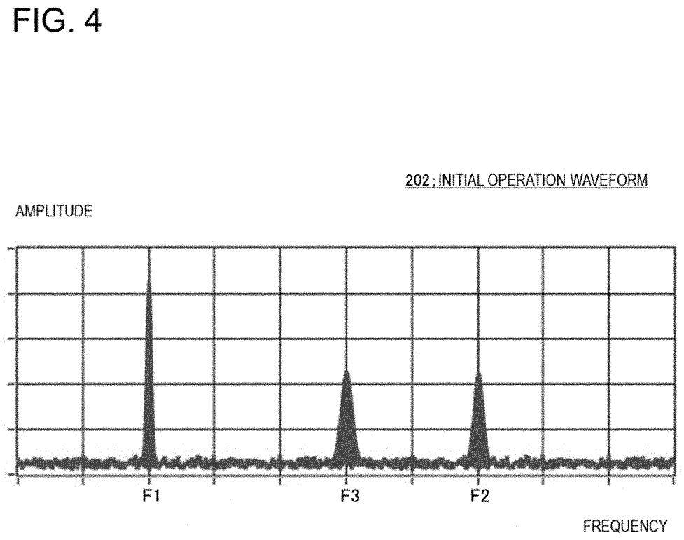

As described above, in the production system, the production material 12 is processed without environmental noise, and a power spectrum that represents characteristics of the vibration caused by the process (by the operation of the production equipment 10) is generated. Namely, the diagnostic apparatus 30 generates a power spectrum that represents characteristics of the vibration in a state in which there is no environmental noise and in which load is placed on the production equipment 10. For example, a power spectrum as illustrated in FIG. 4 is generated and stored as an initial operation waveform 202.

As will be described below, the initial operation waveform 202 is used for creating a threshold used when the process determination is performed. Thus, the process of the production material 12 needs to be performed normally in the initial mode. In other words, the threshold cannot be created from the initial operation waveform 202 that has been acquired in a state in which the process of the production material 12 has not been processed normally. Thus, when the user checks the processed production material 12, if the user determines that the process has not been performed normally, the user discards the acquired initial operation waveform 202 and acquires a new initial operation waveform 202.

Next, the diagnostic apparatus 30 in the initial mode generates the threshold used for the process determination by using the initial operation waveform 202 and stores the generated threshold. The generation of the threshold will be described in detail below.

A general operation in the initial mode has thus been described.

The test mode is a mode performed at predetermined timing, for example, when the process of the production material 12 is started or when a predetermined period has elapsed after the start of the process. The test mode is performed in an environment in which apparatuses other than the production equipment 10 are also operated and in which there are various kinds of noise.

In the test mode, by operating the control apparatus, the user operates the production equipment 10 to which the production material 12 is not attached (without load). In the test mode, for example, the production equipment 10 is also operated with a predetermined initial rotation number for a predetermined time, and the rotation number is increased with a predetermined slope.

As in the initial mode, the diagnostic apparatus 30 in the test mode performs FFT processing on the vibration data acquired from the vibration sensor 20, to generate a power spectrum. The diagnostic apparatus 30 stores and holds the generated power spectrum as the start-up waveform 203. For example, a power spectrum as illustrated in FIG. 5 is generated and stored as the start-up waveform 203.

The normal mode is a mode in which the production material 12 is actually processed. The user sets the production material 12 at the production equipment 10 and operates the control apparatus to process the production material 12.

As in the initial mode and the test mode, the diagnostic apparatus 30 in the normal mode performs FFT processing on the vibration data acquired from the vibration sensor 20, to generate a power spectrum. The diagnostic apparatus 30 stores and holds the generated power spectrum as the operation waveform 204. For example, a frequency spectrum as illustrated in FIG. 6 is generated and stored as the operation waveform 204.

The diagnostic apparatus 30 performs the process determination on the production material 12 in real time by using the previously stored initial waveform 201 and start-up waveform 203 and the operation waveform 204 acquired at the time of the process.

The operation modes (the initial mode, the test mode, and the normal mode) in the production system have roughly been described.

Depending on the situation of the production system, the user determines an operation mode and operates the control apparatus, the production equipment 10, and the diagnostic apparatus 30 based on the determined operation mode. Specifically, when the production equipment 10 is installed at a factory for the first time, the user operates the diagnostic apparatus 30 so that the processing in the initial mode will be performed.

After the processing of the diagnostic apparatus 30 in the initial mode is performed, the production material 12 is processed. When the process of the production material 12 is started, the diagnostic apparatus 30 needs to perform the processing in the “test mode”. Specifically, after the processing in the test mode is performed and the start-up waveform 203 including information about environmental noise in a situation in which the process is actually performed is acquired, the process of the production material 12 can be started.

After entering a test mode execution instruction to the diagnostic apparatus 30, the user enters a normal mode execution instruction to the diagnostic apparatus 30.

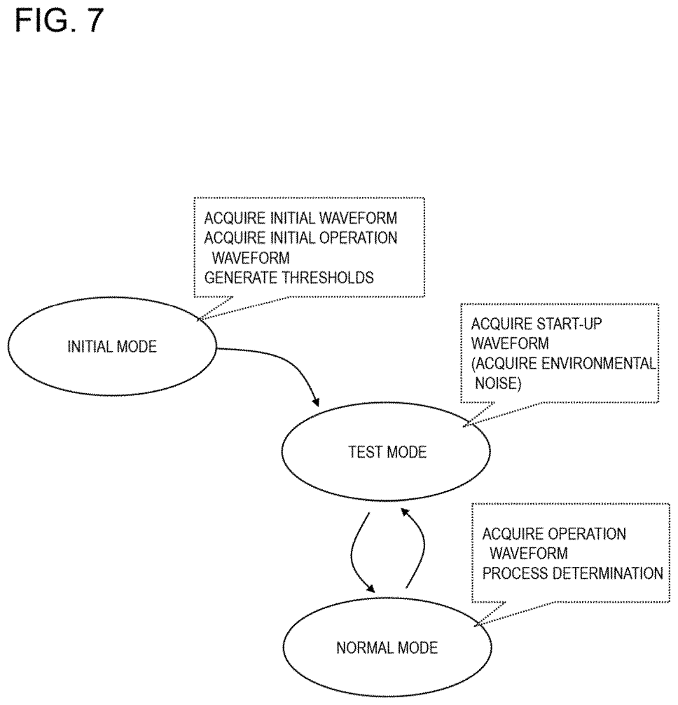

FIG. 7 illustrates a possible state transition of the diagnostic apparatus 30. As illustrated in FIG. 7, the initial mode needs to be performed only once. There is no need to perform the initial mode twice or more. In addition, the processing in the test mode is performed before the processing in the normal mode, to acquire the noise in the environment in which the process is actually started. There are cases in which change of the environmental noise is assumed. For example, the environmental noise could change when another production material 12 is processed after one production material 12 is processed. For example, the environmental noise could change when the process is resumed after temporarily stopped. For example, the environmental noise could change when a long time has elapsed after the process is started. In these cases, the processing in the test mode and the processing in the normal mode are performed in this order, again.

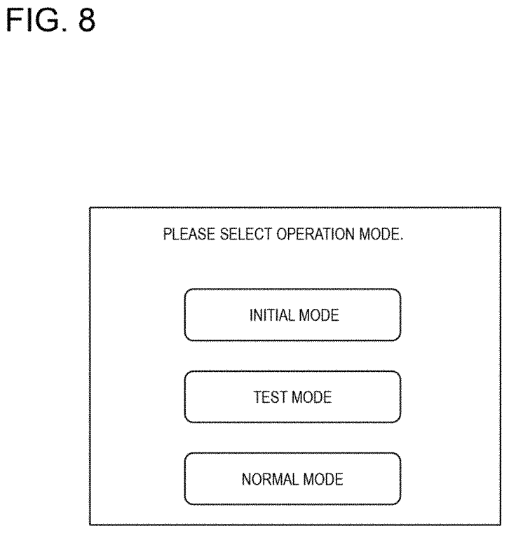

The user may use a graphical user interface (GUI) provided by the diagnostic apparatus 30 when entering an instruction to the diagnostic apparatus 30. For example, the diagnostic apparatus 30 may output information displayed as illustrated in FIG. 8 to a liquid crystal monitor or the like, and the user may enter an operational instruction by using a mouse, a keyboard, or the like. The user may enter the operational instruction to the diagnostic apparatus 30 in any one of various modes and methods (may enter the instruction via a network, for example). Since these modes and methods are apparent to those skilled in the art, detailed description thereof will be omitted.

Next, hardware of the diagnostic apparatus 30 according to the first exemplary embodiment will be described.

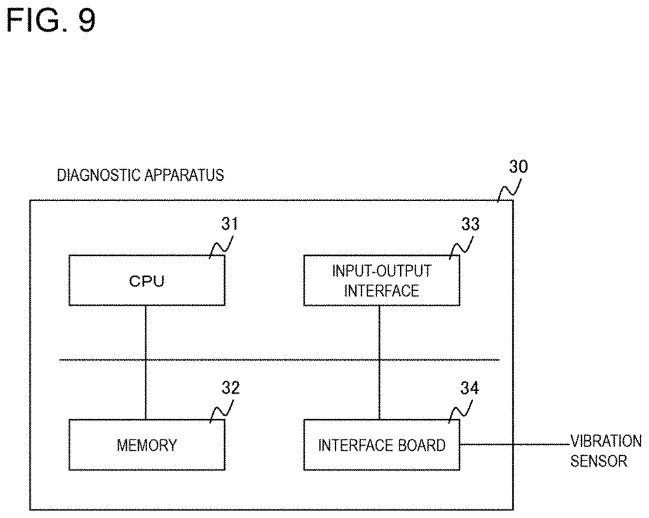

FIG. 9 illustrates a hardware example of the diagnostic apparatus according to the first exemplary embodiment. The diagnostic apparatus 30 can be configured as a so-called information processing apparatus (a computer) and has a configuration illustrated as an example in FIG. 9. For example, the diagnostic apparatus 30 includes a central processing unit (CPU) 31, a memory 32, an input-output interface 33, an interface board 34, etc., which are connected to each other via an internal bus.

The configuration illustrated in FIG. 9 is not intended to limit the hardware configuration of the diagnostic apparatus 30. The diagnostic apparatus 30 may include hardware not illustrated. In addition, for example, the number of CPUs included in the diagnostic apparatus 30 is not limited to the example in FIG. 9. For example, a plurality of CPUs may be included in the diagnostic apparatus 30.

The memory 32 is a random access memory (RAM), a read-only memory (ROM), or an auxiliary storage device (a hard disk or the like).

The input-output interface 33 is means for serving as an interface for a display device and an input device not illustrated. The display device is, for example, a liquid crystal monitor or the like. The input device is, for example, a device such as a keyboard or a mouse that receives user operations.

The interface board 34 is an interface connected to the vibration sensor 20. The interface board 34 converts an analog signal outputted by the vibration sensor 20 into a digital signal and outputs the digital signal to the CPU 31. When the vibration sensor 20 outputs velocity or acceleration as a physical amount, the interface board 34 converts the physical amount into the amount of change (the amount of displacement) and outputs this amount to the CPU 31.

The functions of the diagnostic apparatus 30 are realized by the processing modules to be described below. These processing modules are realized by causing the CPU 31 to execute a program stored in the memory 32, for example. All or a part of the processing modules may be realized by (implemented on) hardware such as a field programmable gate array (FPGA) or an application specific integrated circuit (ASIC). In addition, the program may be updated by downloading a program via a network or by using a storage medium in which a program is stored. The processing modules may be realized by a semiconductor chip. Namely, the functions of the above processing modules may be realized by causing some hardware to perform software.

By installing the above computer program in a storage part of a computer, the computer can serve as the diagnostic apparatus 30. In addition, by causing a computer to execute the above computer program, the computer can perform a diagnostic method for determining whether the production material 12 has been processed normally.

Next, a processing configuration (processing modules) of the diagnostic apparatus 30 according to the first exemplary embodiment will be described.

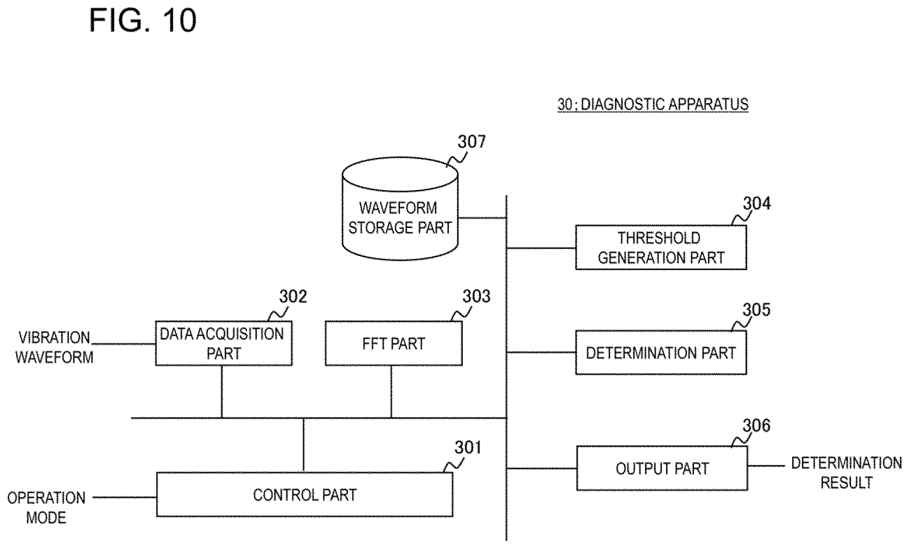

FIG. 10 illustrates an example of a processing configuration of the diagnostic apparatus 30 according to the first exemplary embodiment. As illustrated in FIG. 10, the diagnostic apparatus 30 includes a control part 301, a data acquisition part 302, an FFT part 303, a threshold generation part 304, a determination part 305, an output part 306, and a waveform storage part 307.

The control part 301 is means for comprehensively controlling the diagnostic apparatus 30. For example, the user enters an operation mode of the production system to the diagnostic apparatus 30 by operating an operation device (a mouse or a keyboard) or the like connected to the diagnostic apparatus 30. The control part 301 controls the individual processing modules based on the entered operation mode.

The data acquisition part 302 is means for acquiring the vibration data outputted by the vibration sensor 20 that detects the vibration caused by the production equipment 10 including the rotation mechanism. Specifically, the data acquisition part 302 acquires an output signal (vibration data) from the vibration sensor 20, which is a digital signal converted from an analog signal. The data acquisition part 302 supplies the acquired vibration data to the FFT part 303.

When the FFT part 303 acquires vibration data (acquires a predetermined time of vibration data) sufficient to perform FFT processing, the FFT part 303 performs FFT processing on the vibration data. More specifically, the FFT part 303 performs FFT processing by using the acquired vibration data, to calculate a power spectrum.

The FFT part 303 stores the result of the FFT processing in the waveform storage part 307. As described above, the production system has three operation modes (the initial mode, the test mode, and the normal mode), and a power spectrum per operation mode is generated. In addition, in the initial mode, a power spectrum without load and a power spectrum with load are generated (without rotation of the motor 11 and with rotation of the motor 11).

Namely, the FFT part 303 stores, as the initial waveform 201, a frequency spectrum calculated from the vibration data acquired when the production equipment 10 is operated without load at installation thereof (in the initial mode). In addition, the FFT part 303 stores, as the start-up waveform 203, a frequency spectrum calculated from the vibration data acquired when the production equipment 10 is operated without load. In addition, the FFT part 303 stores, as the operation waveform 204, a frequency spectrum calculated from the vibration data acquired when the production equipment 10 is operated with load. In addition, the FFT part 303 stores, as the initial operation waveform 202, a frequency spectrum calculated from the vibration data acquired when the production equipment 10 is operated with load at installation thereof.

The control part 301 instructs the FFT part 303 to store the generated power spectra so that the generated power spectra can be distinguished based on the operation modes and the presence or absence of load. For example, if the operation mode is the “test mode”, the control part 301 instructs the FFT part 303 to store the result of the FFT processing as the start-up waveform 203.

The threshold generation part 304 is means for generating frequency thresholds used for the process determination performed by the determination part 305 based on the initial waveform 201 and the initial operation waveform 202. Namely, the threshold generation part 304 generates a threshold used for the process determination on the production material 12 from the two power spectra (the initial waveform 201 and the initial operation waveform 202) that can be acquired in the “initial mode”. After the FFT part 303 stores the initial waveform 201 and the initial operation waveform 202, the control part 301 instructs the threshold generation part 304 to generate a threshold.

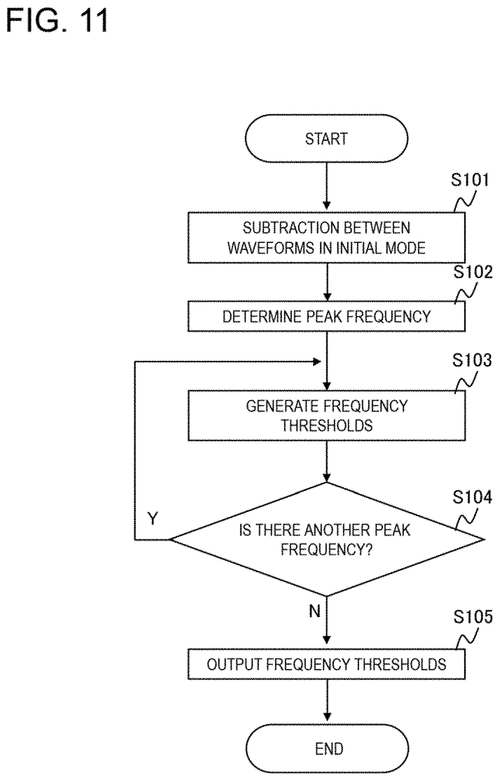

FIG. 11 is a flowchart illustrating an example of an operation of the threshold generation part 304. When receiving an instruction for generating a threshold from the control part 301, the threshold generation part 304 subtracts the initial waveform 201 from the initial operation waveform 202 (subtract waveform of initial mode; step S101).

In the disclosure of the present application, subtraction of one waveform from another waveform (one power spectrum from another power spectrum) indicates subtraction of one amplitude value from another amplitude value at an individual corresponding frequency. When one power spectrum is subtracted from another power spectrum, a frequency component(s) common to both of the spectra is cancelled out, and a power spectrum (a differential waveform) having a frequency component(s) relating to the difference between the spectra is newly generated.

If one power spectrum is subtracted from another spectrum, a frequency whose amplitude indicates a negative value could be generated. In this case, the threshold generation part 304 converts the negative result (amplitude) to a positive value by inverting the negative result. Namely, from the power spectra of the initial operation waveform 202 and the initial waveform 201, the threshold generation part 304 newly generates a power spectrum having a frequency component(s) relating to the difference between the two spectra.

The threshold generation part 304 generates a threshold used for the process determination from the power spectrum obtained by the above subtraction processing. Specifically, the threshold generation part 304 determines a peak frequency (step S102).

Next, the threshold generation part 304 generates values that define a predetermined range having the determined peak frequency as the center, as frequency thresholds (step S103).

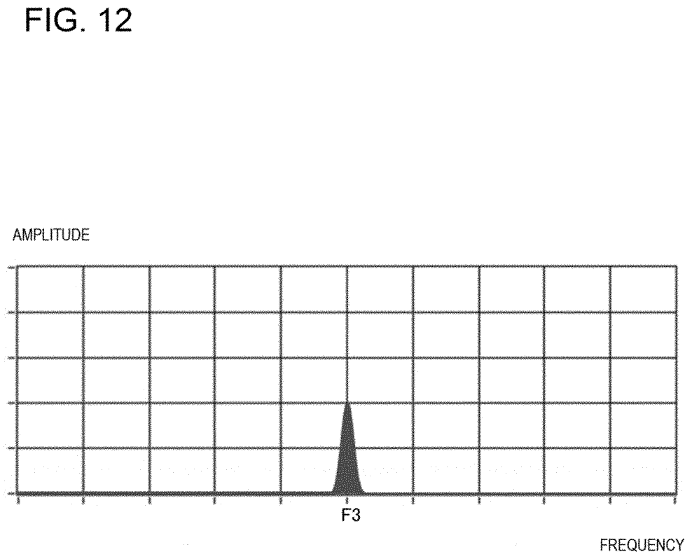

For example, if the initial waveform 201 is subtracted from the initial operation waveform 202 illustrated in FIG. 4, a power spectrum (a differential waveform) illustrated in FIG. 12 is obtained. As illustrated in FIG. 12, a frequency F3 is determined as a peak frequency. The threshold generation part 304 generates two frequencies (F3−α and F3+α) that define a predetermined range (F3−α≤F3<F3+α; α is a positive real number) having the frequency F3 as the center frequency as frequency thresholds.

When the thresholds are generated, the threshold generation part 304 determines whether there is another peak frequency that is other than the previously determined peak frequency, whose amplitude is equal to or more than a predetermined level, and which is away from the previously determined peak frequency by a predetermined frequency or more (step S104).

If the threshold generation part 304 determines such peak frequency (Yes in step S104), the processing returns to step S103 (the threshold generation part 304 generates the next frequency thresholds).

If there is not another peak frequency (No in step S104), the threshold generation part 304 outputs the generated frequency thresholds (step S105). Specifically, the threshold generation part 304 notifies the determination part 305 of the generated frequency thresholds or stores the generated frequency thresholds so that the determination part can refer to the frequency thresholds.

In the disclosure of the present application, the above peak frequency will be referred to as a first peak frequency. In addition, the frequency thresholds corresponding to the first peak frequency will be referred to as “first frequency thresholds”. A frequency away from the first peak frequency by a predetermined frequency and having an amplitude smaller than that of the first peak frequency will be referred to as a second peak frequency. The frequency thresholds corresponding to the second peak frequency will be referred to as “second frequency thresholds”. The frequency thresholds corresponding to another peak frequency will be referred to in the same way as described above.

Hereinafter, an operation of the threshold generation part 304 will be summarized by using the above representation. The threshold generation part 304 determines the first peak frequency and generates the first frequency thresholds corresponding thereto. Next, if the second peak frequency exists, the threshold generation part 304 generates the second frequency thresholds corresponding thereto. The threshold generation part 304 repeats this processing, to generate the frequency thresholds corresponding to an individual peak frequency.

The initial waveform 201 illustrated in FIG. 3 includes a frequency component (a center frequency F1) corresponding to the rotation frequency of the motor 11 and a resonant frequency component (a center frequency F2) of the production equipment 10 caused by the rotation of the motor 11.

Since the initial waveform 201 illustrated in FIG. 3 is a waveform acquired in an unloaded state in which the production material 12 is not processed, the frequency component (vibration) caused by the process is not included. In addition, since the initial mode is performed in a situation in which the operations of other apparatuses, etc. are stopped, large environmental noise is not present, either.

In contrast, since the initial operation waveform 202 illustrated in FIG. 4 is a waveform acquired in a situation (in a loaded state) in which the production material 12 is processed, the frequency component caused by the process is superposed on the waveform illustrated in FIG. 3. In the example illustrated in FIG. 4, the frequency component whose center frequency is F3 appears as the vibration caused by the process.

If the difference between the waveform illustrated in FIG. 4 and the waveform illustrated in FIG. 3 is calculated, the vibration (the frequency component) caused by the process of the production material 12 is extracted from the initial operation waveform 202 (see FIG. 12). As described above, since the initial operation waveform 202 is a waveform that the user has determined that the production material 12 has been processed normally, the power spectrum extracted from the initial operation waveform 202 can be determined to include a frequency component indicating that the process has been performed normally. In other words, if a power spectrum equivalent to the extracted power spectrum (for example, approximately the same center frequency) is obtained when the production material 12 is processed, this process can be determined to have been performed normally.

In contrast, if a power spectrum that significantly differs from the extracted power spectrum is obtained by the process, this process can be determined to have been performed abnormally. For example, if a peak frequency significantly differs or the number of peaks that appear in the power spectrum differs, this process can be determined to have been performed abnormally.

In view of the above fact, the threshold generation part 304 treats a power spectrum that indicates the vibration caused by the process, the power spectrum having been obtained from the two spectra acquired in the initial mode, as an ideal value (a reference) and generates thresholds used for the process determination.

While FIG. 12 illustrates an example in which a power spectrum has a single peak (peak frequency) for ease of the understanding, a power spectrum normally includes a plurality of peaks. In this case, the threshold generation part 304 generates frequency thresholds per peak.

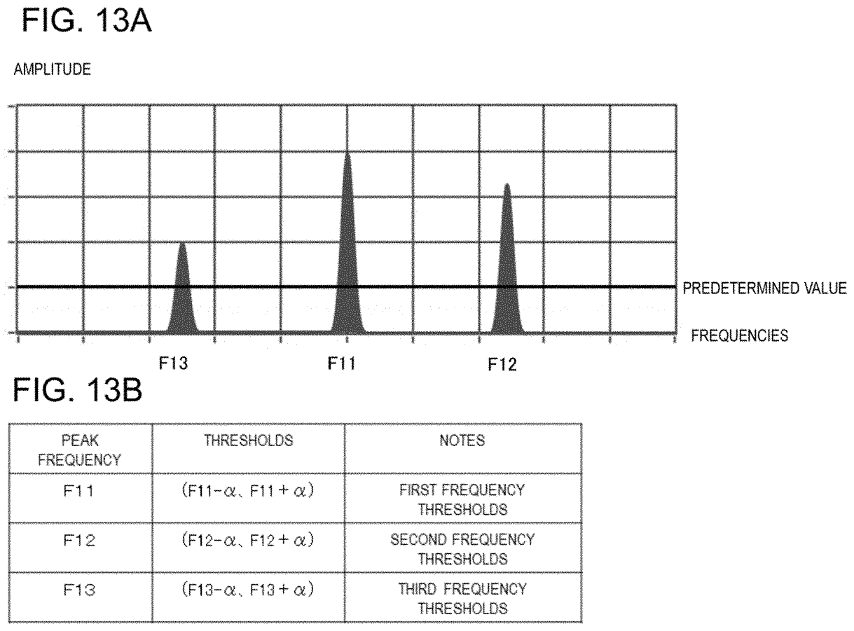

For example, if a waveform illustrated in FIG. 13A is a power spectrum obtained from the difference between the initial operation waveform 202 and the initial waveform 201, the number of peak frequencies larger than a predetermined value is 3. In this case, the threshold generation part 304 generates frequency thresholds for each of the three peak frequencies (see FIG. 13B).

Referring back to FIG. 10, the determination part 305 is means for determining whether the production equipment 10 has processed the production material 12 normally based on the start-up waveform 203 and the operation waveform 204. More specifically, the determination part 305 determines whether the production material 12 has been processed normally in the normal mode. In addition, the determination part 305 corrects the thresholds used for determining whether the production material 12 has been processed normally, based on the initial waveform 201 and the start-up waveform 203.

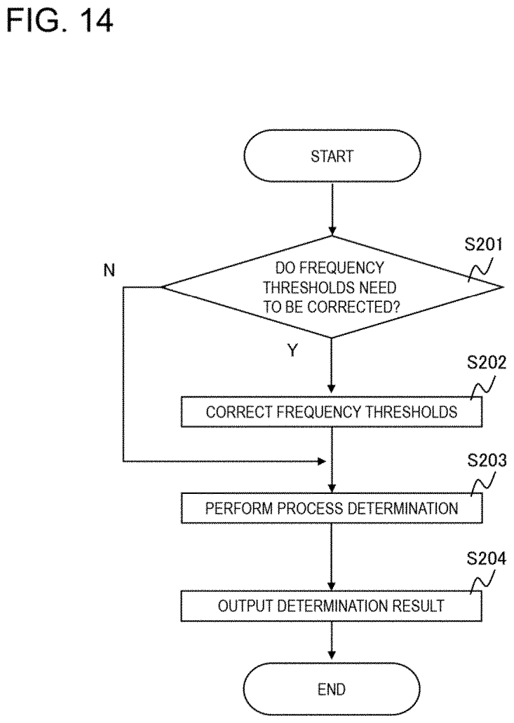

FIG. 14 is a flowchart illustrating an example of an operation of the determination part 305. First, the determination part 305 determines whether the frequency thresholds used for the threshold processing need to be corrected (step S201).

Specifically, the determination part 305 determines the first peak frequency of the initial waveform 201 and the first peak frequency of the start-up waveform 203. The determination part 305 calculates an absolute value of the difference between these two peak frequencies. If the absolute value of the difference is larger than a predetermined value (a threshold), the determination part 305 determines that the frequency thresholds need to be corrected.

In contrast, if the absolute value of the difference is equal to or less than the threshold, the determination part 305 determines that the frequency thresholds do not need to be corrected.

If the frequency thresholds need to be corrected (Yes in step S201), the determination part 305 corrects the frequency thresholds based on the above correction value (step S202). Specifically, the determination part 305 subtracts the first peak frequency of the initial waveform from the first peak frequency of the start-up waveform and calculates the value as the correction value of the frequency thresholds.

Next, the determination part 305 corrects the frequency thresholds by adding the calculated correction value to the frequency thresholds (two thresholds).

If there are a plurality of frequency thresholds, the determination part 305 corrects the individual frequency thresholds by adding the correction value to the individual frequency thresholds.

If the frequency thresholds do not need to be corrected (NO in step S201), the processing proceeds to step 5203. Namely, the determination part 305 does not perform any particular processing.

As described above, the determination part 305 calculates the difference between an individual peak frequency of the start-up waveform 203 and an individual peak frequency of the initial waveform 201 as the correction value used to correct the frequency thresholds. Next, the determination part 305 adds the correction value to the frequency thresholds. The corrected frequency thresholds are used for the process determination by the determination part 305.

The first peak frequency of the initial waveform 201 and the first peak frequency of the start-up waveform 203 are assumed to correspond to the rotation frequency of the motor 11. Namely, the determination part 305 calculates the absolute value of the difference between the first peak frequencies of the two waveforms, assuming that the energy of the vibration caused by the rotation of the motor 11 is larger than other vibrations. If the energy of the vibration caused by the resonance of the chassis of the production equipment 10 is larger than the energy of the vibration caused by the rotation of the motor 11, the determination part 305 may calculate the absolute value of the difference between the second peak frequencies in the two waveforms. Namely, the determination part 305 calculates the difference between the rotation frequencies of the motor 11 in the two waveforms and calculates the correction value for the frequency thresholds.

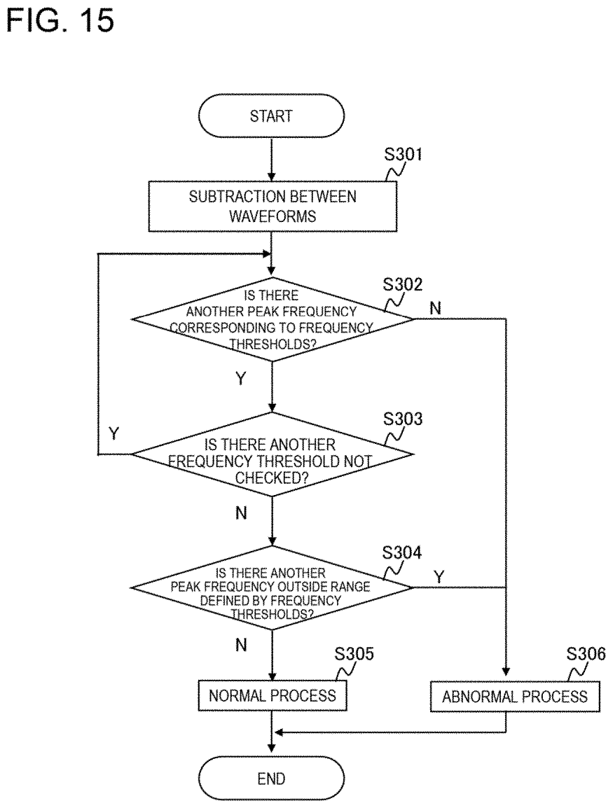

In step S203 in FIG. 14, the determination part 305 performs the process determination. The process determination by the determination part 305 will be described with reference to FIG. 15.

FIG. 15 is a flowchart illustrating an example of an operation of the process determination by the determination part 305.

The determination part 305 generates a power spectrum used for the process determination by subtracting the start-up waveform 203 from the operation waveform 204 (step S301).

Next, the determination part 305 determines whether a peak frequency exists in a range defined by frequency thresholds (step S302). Specifically, the determination part 305 determines whether a peak frequency of the power spectrum generated in step S301 falls within a range defined by frequency thresholds or corrected frequency thresholds.

If a peak frequency corresponding to the frequency thresholds does not exist (No in step S302), the determination part 305 proceeds to and performs step S306.

If a peak frequency corresponding to the frequency thresholds exists (Yes in step S302), the determination part 305 determines whether there are frequency thresholds that have not been checked (step S303).

If there are frequency thresholds that have not been checked (Yes in step S303), the determination part 305 returns to and performs step S302.

If there are no frequency thresholds that have not been checked (No in step S303), the determination part 305 determines whether there is a peak frequency outside any range defined by the frequency thresholds (step S304).

For example, while FIG. 13B illustrates three pairs of frequency thresholds as an example, the determination part 305 determines whether the power spectrum generated in step S301 includes a peak frequency (a frequency whose amplitude indicates a predetermined value or more) other than the peak frequencies corresponding to these three pairs of frequency thresholds.

If a peak frequency that does not correspond to any pair of frequency thresholds exists (Yes in step S304), the determination part 305 proceeds to and performs step S306.

If a peak frequency that does not correspond to any pair of frequency thresholds does not exist (No in step S304), the determination part 305 proceeds to and performs step S305.

In step S305, the determination part 305 sets the process determination result to “normal process”.

In step S306, the determination part 305 sets the process determination result to “abnormal process”.

In this way, the determination part 305 determines whether the production material 12 has been processed normally, based on the differential waveform obtained from the difference between the operation waveform 204 and the start-up waveform 203. More specifically, based on whether an individual peak frequency of the differential waveform exists in the range defined by the corresponding frequency thresholds, the determination part 305 determines whether the production material 12 has been processed normally. Namely, the determination part 305 determines whether an individual peak frequency corresponding to its frequency thresholds exists in the power spectrum generated by the difference between the waveforms. If there is a single peak frequency that does not correspond to any pair of frequency thresholds, the determination part 305 determines “abnormal process”. In addition, the determination part 305 also determines “abnormal process” if there is a peak frequency other than the peak frequencies defined by the frequency thresholds in the generated power spectrum.

Next, referring back to FIG. 14, the determination part 305 notifies the control part 301 of the process determination result (step S204).

Next, an operation of the determination part 305 will be described in detail with reference to drawings.

A peak frequency of the initial waveform 201 illustrated in FIG. 3 is the frequency F1. A peak frequency of the start-up waveform 203 illustrated in FIG. 5 is a frequency F1′.

The absolute value of the difference between the two peak frequencies calculated by the determination part 305 is |F1′−F1|. It can be considered that this difference is caused by change of the rotation frequency that has occurred by age deterioration of the motor 11. If this difference is larger than a predetermined value (threshold), the determination part 305 determines that the frequency thresholds need to be corrected. Specifically, β=|F1′−F1| is calculated as the correction value for the frequency thresholds.

As in the above example, if the frequency thresholds generated by the threshold generation part 304 are (F3−α, F3+α), the frequency thresholds are corrected to (F3−α+β, F3+α+β).

Next, as illustrated in FIG. 5 and FIG. 6, there are frequency components (frequencies F4 to F7) that can be considered as environmental noise, in addition to the frequency component (center frequency F1′) due to the rotation of the motor 11 and the frequency component (center frequency F2) due to the resonance of the chassis.

Since the start-up waveform 203 illustrated in FIG. 5 is a frequency spectrum obtained when the production material 12 is not processed (in an unloaded state), the start-up waveform 203 does not include a frequency component (vibration) caused by the process of the production material 12. In contrast, the operation waveform 204 illustrated in FIG. 6 includes a frequency component (a center frequency F3′) that occurs due to the process of the production material 12.

If the start-up waveform 203 illustrated in FIG. 5 is subtracted from the operation waveform 204 illustrated in FIG. 6, the frequency components common to both of the waveforms are cancelled out, the frequency component that exists only in the operation waveform 204 is extracted.

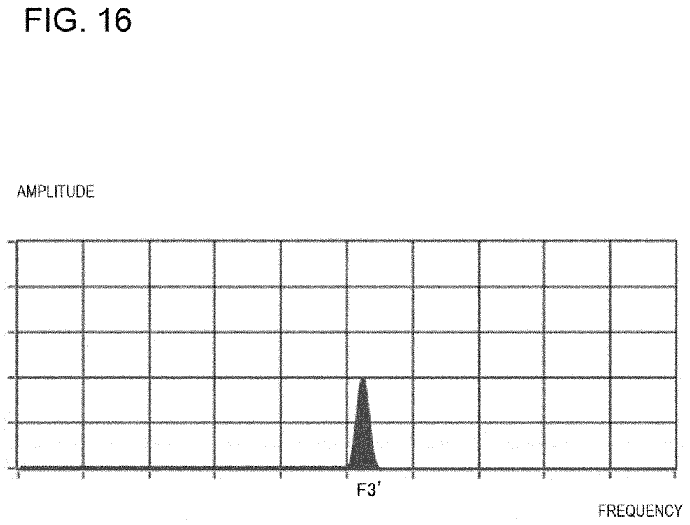

FIG. 16 illustrates an example of the result obtained by subtracting the start-up waveform 203 from the operation waveform 204. As illustrated in FIG. 16, the frequency component (center frequency F3′) that occurs due to the process of the production material 12 is extracted, and the peak frequency (first peak frequency) of the power spectrum obtained from the differential waveform is F3′.

In addition, as described above, since the corrected frequency thresholds are (F3−α+β, F3+α+β), if the peak frequency F3′ illustrated in FIG. 16 is included in the range defined by the above two frequency thresholds, the process can be determined to be “normal”.

Next, referring back to FIG. 10, when acquiring the process determination result from the determination part 305, the control part 301 supplies the result to the output part 306.

The output part 306 outputs the process determination result to the outside. For example, the output part 306 displays the process determination result on a liquid crystal monitor or the like or transmits the process determination result to an external management center or the like. Alternatively, when the process determination result indicates “abnormal process”, the output part 306 may output a warning alarm or turn on warning light, for example.

As described above, the diagnostic apparatus 30 according to the first exemplary embodiment generates frequency spectra based on the vibration data obtained from the vibration sensor 20 in the initial mode, the test mode, and the normal mode. Next, the diagnostic apparatus 30 calculates the difference between the start-up waveform 203 acquired in the test mode and the operation waveform 204 acquired in the normal mode and removes the environmental noise commonly superposed on the two waveforms. The diagnostic apparatus 30 can perform more accurate determination by performing the process determination on the waveform from which the environmental noise has been removed. In addition, if the diagnostic apparatus 30 determines that the production equipment 10 (the motor 11) has deteriorated with age from the initial waveform 201 acquired in the initial mode and the start-up waveform 203 acquired in the test mode, the diagnostic apparatus 30 corrects the thresholds by using a correction value generated from these waveforms. Consequently, even if the production equipment 10 has deteriorated with age, the diagnostic apparatus 30 can perform stable determination by performing the process determination by using the corrected thresholds.

### Second Exemplary Embodiment

Next, a second exemplary embodiment will be described in detail with reference to drawings.

The first exemplary embodiment has been described, assuming that the process determination is performed by using a single vibration sensor 20. The second exemplary embodiment will be described, assuming that a plurality of vibration sensors 20 are used.

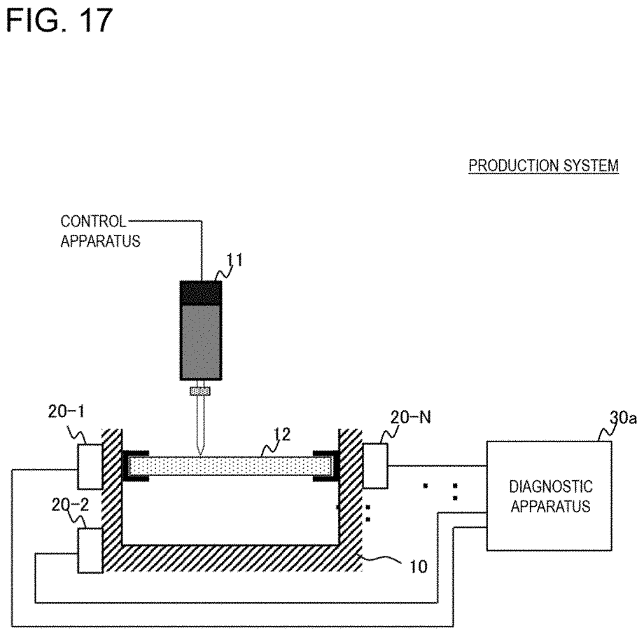

FIG. 17 illustrates an example of a production system according to the second exemplary embodiment. As seen from the comparison between FIG. 2 and FIG. 17, the production system according to the second exemplary embodiment differs from the production system according to the first exemplary embodiment in that a plurality of vibration sensors 20-1 to 20-N (hereinafter, N will be a positive integer) are included.

A diagnostic apparatus 30a according to the second exemplary embodiment performs the processing described in the first exemplary embodiment on an individual one of the plurality of vibration sensors 20-1 to 20-N. Specifically, the diagnostic apparatus 30a acquires an initial waveform 201, an initial operation waveform 202, a start-up waveform 203, and an operation waveform 204 per vibration sensor 20. Next, the diagnostic apparatus 30a performs the threshold generation, the threshold correction, and the process determination per vibration sensor 20.

The diagnostic apparatus 30a may output a determination result per vibration sensor 20 or generate a final determination result after integrating a plurality of determination results. Namely, an output part 306 according to the second exemplary embodiment may determine and output a determination result for the entire system, based on the determination results regarding the respective vibration sensors 20 obtained by a determination part 305. For example, the output part 306 may change the warning level depending on the number of “abnormal processes” included in a plurality of determination results. Specifically, for example, if results indicating a small number of “abnormal processes” are obtained, the output part 306 may output a low warning level. In contrast, if results indicating a large number of “abnormal processes” are obtained, the output part 306 may output a high warning level.

The individual vibration sensors 20 are arranged so that harmonics of the rotation frequency of the motor 11 do not overlap with each other. For example, two vibration sensors 20-1 and 20-2 are arranged away from each other by a predetermined distance so that the first-order harmonic of the rotation frequency of the motor 11 in the frequency spectrum acquired by the vibration sensor 20-1 does not overlap with the rotation frequency (fundamental wave) of the motor 11 acquired by the vibration sensor 20-2.

For example, the wavelength of the rotation frequency of the motor 11 may be denoted by λ, and the distance between the two vibration sensors 20 may be denoted by λ/4. By arranging the individual vibration sensors 20 so that the wavelengths thereof are different by λ/4, the frequency spectra acquired by neighboring vibration sensors 20 are not superposed.

The above inter-sensor distance (λ/4) is an example. The plurality of vibration sensors 20 may be arranged in an arbitrary manner as long as harmonics of the rotation frequency of the motor 11 of the production equipment 10 do not overlap with each other.

In addition, the diagnostic apparatus 30a according to the second exemplary embodiment may have the same hardware configuration and processing configuration as those illustrated in FIGS. 9 and 10. Thus, the detailed description thereof will be omitted. For example, the processing modules (for example, the FFT part 303, the threshold generation part 304, and the determination part 305) in FIG. 10 may perform the processing relating to all the vibration sensors 20-1 to 20-N. Alternatively, the processing modules may be prepared per sensor.

As described above, the diagnostic apparatus 30a according to the second exemplary embodiment acquires vibration data outputted by at least two vibration sensors 20. Next, by using the FFT part 303, the diagnostic apparatus 30a calculates the initial waveform 201, the start-up waveform 203, and the operation waveform 204 from the vibration data obtained from the at least two vibration sensors 20. Next, the diagnostic apparatus 30a determines whether the production material 12 has been processed normally by the production equipment 10 regarding each of the at least two vibration sensors 20. As a result, since vibration that cannot be detected by a single vibration sensor 20 can be detected by another vibration sensor 20, the diagnostic apparatus 30a can output an accurate determination result.

### Third Exemplary Embodiment

Next, a third exemplary embodiment will be described in detail with reference to drawings.

The first and second exemplary embodiments have been described, assuming that power spectra are acquired by using a vibration sensor(s). The third exemplary embodiment will be described, assuming that an acoustic sensor is used in addition to a vibration sensor.

It is fair to say that vibration sensors and acoustic sensors are the same kind of sensors in a sense that these sensors detect “vibration. Namely, a vibration sensor detects vibration propagated through a solid object, and an acoustic sensor detects vibration propagated through space. Thus, these two sensors detect the same frequency component from the same vibration source.

However, under certain conditions, while one sensor can detect vibration from a vibration source, the other sensor cannot detect the vibration from the same vibration source. Specifically, while vibration is caused when the production material 12 is processed, antiresonance could simultaneously be caused by the process of the production material 12.

If the frequency of the antiresonance matches (or is very close to) the frequency of the vibration caused by the process, the two vibrations could be cancelled out, and the frequency of the vibration could not be detected by the vibration sensor. Meanwhile, while the acoustic sensor can detect vibration (acoustic wave) caused when the production material 12 is processed, the acoustic sensor cannot detect the vibration caused by the antiresonance.

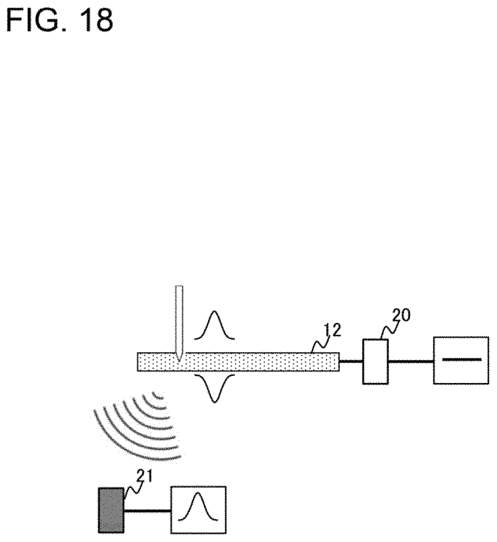

FIG. 18 illustrates this situation. In FIG. 18, there are vibration caused by the process of the production material 12 and its antiresonance that matches (or is close to) the frequency vibration. In this case, the two vibrations are cancelled out and are not reflected on the vibration data outputted by the vibration sensor 20. In contrast, the acoustic sensor 21 can detect only the vibration caused by the process of the production material 12.

According to the third exemplary embodiment, more accurate process determination is performed by using the difference between characteristics of a vibration sensor and an acoustic sensor.

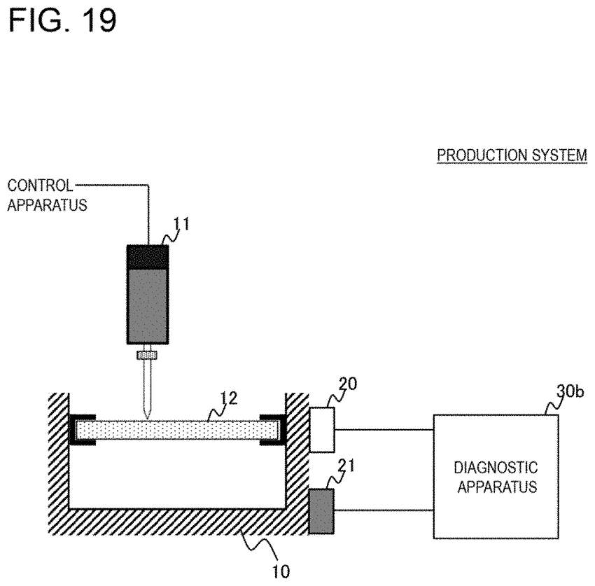

FIG. 19 illustrates an example of a production system according to the third exemplary embodiment. As seen from the comparison between FIG. 2 and FIG. 19, the production system according to the third exemplary embodiment differs from the production system according to the first exemplary embodiment in that an acoustic sensor 21 is included in addition to a vibration sensor 20.

The acoustic sensor 21 converts spatially propagating acoustic waves into electrical signals and outputs the electrical signals to a diagnostic apparatus 30b.

The diagnostic apparatus 30b according to the third exemplary embodiment may have the same hardware configuration and processing configuration as those illustrated in FIGS. 9 and 10. Thus, the detailed description thereof will be omitted.

The diagnostic apparatus 30b according to the third exemplary embodiment treats the vibration sensor 20 and the acoustic sensor 21 as independent sensors and generates an initial waveform 201, an initial operation waveform 202, a start-up waveform 203, and an operation waveform 204 from each of the sensors.

A threshold generation part 304 compares an initial operation waveform 202a generated from the data of the vibration sensor 20 with an initial operation waveform 202b generated from the data of the acoustic sensor 21. Next, the threshold generation part 304 determines whether there is a peak (a frequency component whose amplitude is larger than a predetermined value) that exists in the initial operation waveform 202b and that does not exist in the initial operation waveform 202a.

As a result of the determination, if there is the above peak, the threshold generation part 304 copies the peak (a predetermined range including the center frequency) to the initial operation waveform 202a. Next, by using the initial operation waveform 202a to which the peak existing only in the initial operation waveform 202b has been copied, the threshold generation part 304 generates thresholds in the same way as described in the first exemplary embodiment.

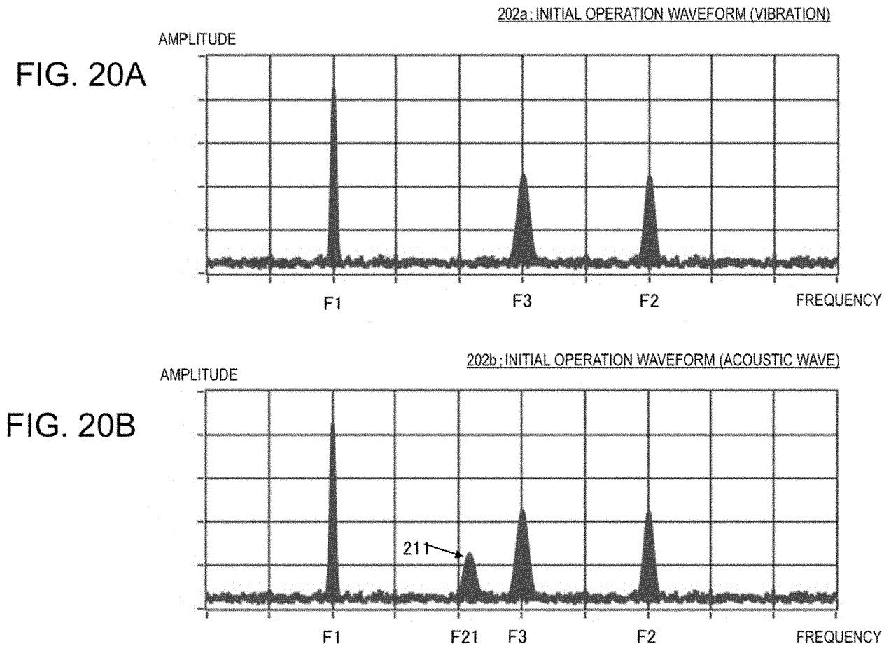

For example, assuming that a power spectrum illustrated in FIG. 20A is stored as the initial operation waveform 202a and a power spectrum illustrated in FIG. 20B is stored as the initial operation waveform 202b, a peak 211 having a center frequency F21 exists in the initial operation waveform 202b. The threshold generation part 304 copies this peak 211 to the initial operation waveform 202b and generates thresholds in the same way as described in the first exemplary embodiment.

Namely, when the vibration caused by the process of the production material 12 and the peak 211 based on the antiresonance of the production material 12 are cancelled out and when the vibration cannot be detected by the vibration sensor 20, the threshold generation part 304 generates thresholds by using the waveform (power spectrum) on which the peak 211 detected by the acoustic sensor 21 has been reflected.

In addition, the determination part 305 also performs processing in the same way as that of the threshold generation part 304. Specifically, the determination part 305 compares an operation waveform 204a generated from the data of the vibration sensor 20 with an operation waveform 204b generated from the data of the acoustic sensor 21 and determines whether there is a peak that exists in the operation waveform 204b and that does not exist in the operation waveform 204a.

As a result of the determination, if there is the above peak, the determination part 305 copies the peak (a predetermined range including the center frequency) to the operation waveform 204a. Next, by using the operation waveform 204a to which the peak existing only in the operation waveform 204b has been copied, the determination part 305 performs the process determination in the same way as described in the first exemplary embodiment.

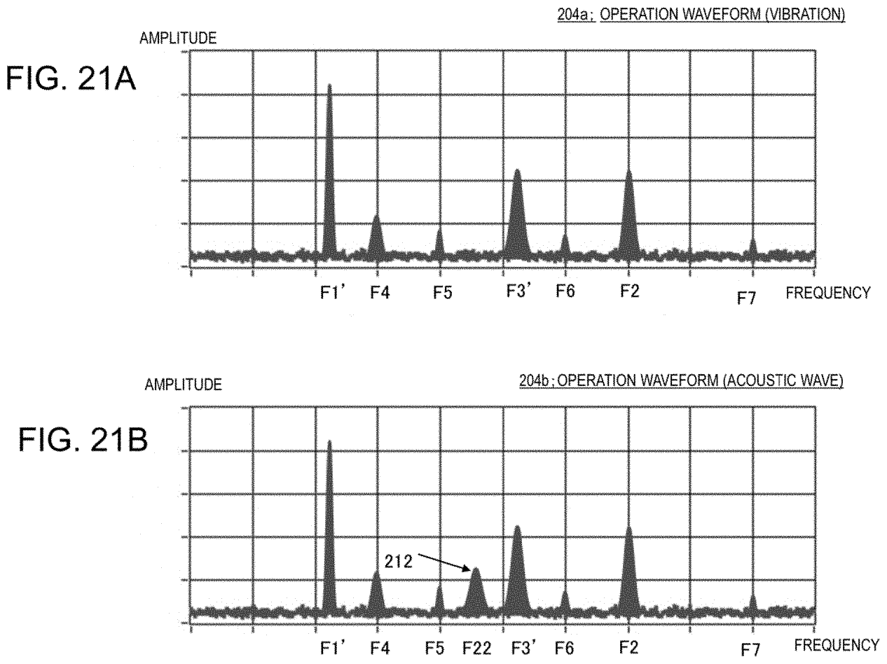

For example, assuming that a power spectrum illustrated in FIG. 21A is stored as the operation waveform 204a and a power spectrum illustrated in FIG. 21B is stored as the operation waveform 204b, a peak 212 having a center frequency F22 exists in the operation waveform 204b. The determination part 305 copies this peak 212 to the operation waveform 204a and performs the process determination in the same way as described in the first exemplary embodiment.

Namely, when the vibration caused by the process of the production material 12 and the peak 212 based on the antiresonance of the production material 12 are cancelled out and when the vibration cannot be detected by the vibration sensor 20, the determination part 305 performs the process determination by using the waveform (power spectrum) on which the peak 212 detected by the acoustic sensor 21 has been reflected.

As described above, the diagnostic apparatus 30b according to the third exemplary embodiment reflects a waveform(s) (a peak(s)) that exists only in a power spectrum acquired by the acoustic sensor 21 on a power spectrum acquired from the vibration sensor 20 and performs the threshold generation and the process determination. As a result, the vibration cancelled out, for example, by the antiresonance of the production material 12 can be reflected on the power spectrum acquired from the vibration sensor 20, and therefore, the diagnostic apparatus 30b can perform the process determination more accurately.

### [Variation]

The configurations and operations of the production systems described in the first to third exemplary embodiments are examples, and various variations may be made to the production systems.

For example, while the above exemplary embodiments assume that an individual vibration sensor 20 is a sensor that can detect a single-axis vibration, a single vibration sensor 20 may detect a two-axis or three-axis vibration. In this case, the diagnostic apparatus 30 may treat the vibration data of an individual axis outputted by a single vibration sensor 20 as the output from an independent vibration sensor. Namely, as described in the second exemplary embodiment, the diagnostic apparatus 30 may perform the waveform calculation, the threshold generation, and the process determination for each axis of the vibration sensor 20.

In the above exemplary embodiments, while the FFT part 303 calculates a frequency spectrum relating to a power spectrum from vibration data, the FFT part 303 may calculate a Fourier spectrum obtained from FFT decomposition without calculating a power spectrum. Namely, the FFT part 303 may calculate another kind of waveform.

While the third exemplary embodiment assumes an example in which the acoustic sensor 21 is used as an auxiliary sensor for the vibration sensor 20, the acoustic sensor 21 and the vibration sensor 20 may be used as sensors at the same level. Namely, the diagnostic apparatus 30b may perform the waveform calculation, the threshold generation, and the process determination by using the acoustic sensor as a main sensor. Namely, the production systems according to the above exemplary embodiments include at least one of a vibration sensor and an acoustic sensor.

In the above exemplary embodiments, how the vibration changes depending on the process situation of the production material 12 is not considered. However, if a waveform (a power spectrum) that is obtained significantly changes depending on the process situation of the production material 12, the threshold generation and the process determination may be performed per process situation. For example, when a hole is made in the production material 12, if the vibration corresponding to the normal process of the production material 12 differs depending on the depth of the hole, generation of a power spectrum, calculation of thresholds, and determination of the process may be performed per depth. Namely, the diagnostic apparatus 30 may perform the processing relating to the initial mode, the test mode, and the normal mode per process situation and may generate thresholds and perform the process determination per process situation. As a result, the diagnostic apparatus 30 can perform the process determination more accurately.

In the above exemplary embodiments, whether the thresholds need to be corrected is determined each time the production material 12 is processed. However, if it is apparent that the production equipment 10 has not deteriorated with age, for example, if not much time has elapsed since the installation of the production equipment 10, the determination of whether the thresholds need to be corrected or the correction of the thresholds may be omitted.

While the above exemplary embodiments assume a case in which the diagnostic apparatus 30 generates the thresholds used for the process determination, the user may check the initial waveform 201 and the initial operation waveform 202 and determine the thresholds. Namely, the thresholds may be determined manually not automatically. Alternatively, the user may correct the thresholds generated by the diagnostic apparatus 30, and the process determination may be performed by using the thresholds corrected by the user.

The above exemplary embodiments assume an example in which the process determination is performed by using frequency thresholds. However, in place of the frequency thresholds or in addition to the frequency thresholds, other thresholds may be used for the process determination. For example, in addition to the frequency thresholds, the threshold generation part 304 may generate a threshold for determining the degree of the spread of the vibration caused by the process. For example, the threshold generation part 304 may use, as a threshold, an area of the differential waveform obtained from the difference between the two waveforms (the initial waveform 201 and the initial operation waveform 202). In this case, the determination part 305 determines whether an area of the differential waveform obtained from the difference between the start-up waveform 203 and the operation waveform 204 falls within a range defined by an area threshold generated by the threshold generation part 304 (an area defined by two thresholds) and performs the process determination based on the result of the above determination.

In the above exemplary embodiments, while the determination part 305 performs the process determination based on a waveform obtained at the time of the process determination, the determination part 305 may use a waveform obtained in the past for the process determination. For example, the determination part 305 may compare a previously obtained differential waveform (the difference between the start-up waveform 203 and the operation waveform 204) with the latest differential waveform. In this case, if the difference due to change is small, the determination part 305 may determine the process to be “normal process”. In contrast, if the difference due to change is large, the determination part 305 may determine the process to be “abnormal process”.

While the above exemplary embodiments assume a case in which the process determination is performed by using thresholds, the process determination may be performed by using another method. For example, the determination part 305 may perform the process determination by performing pattern matching of a normal waveform (the initial operation waveform 202) and a waveform (the operation waveform 204) obtained at the time of the process. Alternatively, a large number of waveforms corresponding to a normal and a large number of waveforms corresponding to an abnormal process may be prepared, and a learning model relating to the process determination may be used by using the data as training data. In this case, by entering the operation waveform 204 to the previously prepared learning model, the determination part 305 may perform the process determination on the waveform.

While the above exemplary embodiments have been described assuming that the control apparatus and the diagnostic apparatus 30 are different apparatuses, functions of these apparatuses may be realized by a single apparatus. Namely, functions of the diagnostic apparatus 30 may be incorporated into the control apparatus. Alternatively, functions of the control apparatus may be incorporated into the diagnostic apparatus 30. Alternatively, the control apparatus and the diagnostic apparatus 30 may be configured to coordinate with each other, and for example, the control processing on the motor 11 in the individual operation modes may be performed automatically.

While a plurality of steps (processing) are sequentially described in the plurality of flowcharts used in the above description, the execution orders of the steps executed in the individual exemplary embodiments are not limited to the sequences described. In the individual exemplary embodiments, the orders of the steps illustrated may be changed as long as the change does not cause problems in term of content. For example, a plurality of processing may be executed in parallel. The individual exemplary embodiments described above may be combined as long as the combination does not cause contradiction in terms of content.

The disclosure of each of the above PTLs, etc. that have been referred to is incorporated herein by reference thereto. Variations and adjustments of the exemplary embodiments and examples are possible within the scope of the overall disclosure (including the claims) of the present invention and based on the basic technical concept of the present invention. Various combinations and selections of various disclosed elements (including the elements in each of the claims, exemplary embodiments, examples, drawings, etc.) are possible within the scope of the overall disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10 production equipment

11 motor

12 production material

20, 20-1 to 20-N vibration sensor

21 acoustic sensor

30, 30a, 30b, 100 diagnostic apparatus

31 CPU (central processing unit)

32 memory

33 input-output interface

34 interface board

101 acquisition part

102, 303 FFT part

103, 305 determination part

201 initial waveform

202, 202a, 202b initial operation waveform

203 start-up waveform

204, 204a, 204b operation waveform

211, 212 peak

301 control part

302 data acquisition part

304 threshold generation part

306 output part

307 waveform storage part

What is claimed is:

1. A diagnostic apparatus, comprising:
an acquisition part that acquires vibration data outputted by a sensor that detects vibration caused by production equipment having a rotation mechanism;
a fast Fourier transform (FFT) part that stores, as an initial waveform, a frequency spectrum calculated from the vibration data acquired when the production equipment is operated without load at installation thereof, stores, as a start-up waveform, a frequency spectrum calculated from the vibration data acquired when the production equipment is operated without load, and stores, as an operation waveform, a frequency spectrum calculated from the vibration data acquired when the production equipment is operated with load; and
a determination part that determines whether the production equipment has processed production material normally, based on the start-up waveform and the operation waveform;
wherein the determination part corrects a threshold(s) used for determining whether the production material has been processed normally, based on the initial waveform and the start-up waveform.

2. The diagnostic apparatus according to claim 1; wherein the determination part determines whether the production material has been processed normally, based on a differential waveform obtained from a difference between the operation waveform and the start-up waveform.

3. The diagnostic apparatus according to claim 2; wherein the determination part determines whether the production material has been processed normally, based on whether a peak frequency of the differential waveform falls within a range defined by frequency thresholds.

4. The diagnostic apparatus according to claim 3; wherein the determination part uses a difference between a peak frequency of the start-up waveform and a peak frequency of the initial waveform as a correction value used for correcting the thresholds.

5. The diagnostic apparatus according to claim 4; wherein the determination part adds the correction value to the frequency thresholds and determines whether the production material has been processed normally using the frequency thresholds to which the correction value has been added.

6. The diagnostic apparatus according to claim 3;
wherein the FFT part stores, as an initial operation waveform, a frequency spectrum calculated from the vibration data acquired when the production equipment is operated with load at installation thereof; and
wherein the diagnostic apparatus further comprises a threshold generation part that generates the frequency thresholds based on the initial waveform and the initial operation waveform.

7. The diagnostic apparatus according to claim 1;
wherein the acquisition part acquires vibration data outputted by at least two sensors, each of which corresponding to the sensor;
wherein the FFT part calculates the initial waveform, the start-up waveform, and the operation waveform from an individual one of the vibration data outputted by the at least two sensors; and
wherein the determination part determines whether the production equipment has processed the production material normally regarding an individual one of the at least two sensors.

8. The diagnostic apparatus according to claim 7, further comprising an output part that determines and outputs a determination result for a system as a whole, based on a determination result regarding an individual one of the at least two sensors obtained by the determination part.

9. The diagnostic apparatus according to claim 8; wherein the at least two sensors are arranged so that harmonics of a rotation frequency of the rotation mechanism of the production equipment do not overlap with each other.

10. The diagnostic apparatus according to claim 1; wherein the individual sensor is at least one of a vibration sensor and an acoustic sensor.

11. The diagnostic apparatus according to claim 1;
wherein the acquisition part acquires vibration data outputted by a vibration sensor and vibration data outputted by an acoustic sensor;
wherein the FFT part generates the operation waveform corresponding to the vibration sensor and the operation waveform corresponding to the acoustic sensor; and
wherein the determination part reflects a waveform that exists in the operation waveform of the acoustic sensor and that does not exist in the operation waveform of the vibration sensor on the operation waveform of the vibration sensor and determines whether the production equipment has processed the production material normally by using the operation waveform of the vibration sensor on which the waveform has been reflected.

12. (canceled)

13. A diagnostic method, comprising:
causing a diagnostic apparatus, which includes an acquisition part that acquires vibration data outputted by a sensor that detects vibration caused by production equipment having a rotation mechanism and a fast Fourier transform (FFT) part that stores, as an initial waveform, a frequency spectrum calculated from the vibration data acquired when the production equipment is operated without load at installation thereof, stores, as a start-up waveform, a frequency spectrum calculated from the vibration data acquired when the production equipment is operated without load, and stores, as an operation waveform, a frequency spectrum calculated from the vibration data acquired when the production equipment is operated with load, to correct a threshold(s) used for determining whether production material has been processed normally, based on the initial waveform and the start-up waveform; and
causing the diagnostic apparatus to determine whether the production equipment has processed the production material normally, based on the corrected threshold(s), the start-up waveform, and the operation waveform.

14. A non-transient computer readable medium storing a program, causing a computer mounted on a diagnostic apparatus, which includes an acquisition part that acquires vibration data outputted by a sensor that detects vibration caused by production equipment having a rotation mechanism and a fast Fourier transform (FFT) part that stores, as an initial waveform, a frequency spectrum calculated from the vibration data acquired when the production equipment is operated without load at installation thereof, stores, as a start-up waveform, a frequency spectrum calculated from the vibration data acquired when the production equipment is operated without load, and stores, as an operation waveform, a frequency spectrum calculated from the vibration data acquired when the production equipment is operated with load, to perform processing for:
correcting a threshold(s) used for determining whether production material has been processed normally, based on the initial waveform and the start-up waveform; and
determining whether the production equipment has processed the production material normally, based on the corrected threshold(s), the start-up waveform, and the operation waveform.

15. The diagnostic method according to claim 13, comprising:
determining whether the production material has been processed normally, based on a differential waveform obtained from a difference between the operation waveform and the start-up waveform.

16. The diagnostic method according to claim 15, comprising:
determining whether the production material has been processed normally, based on whether a peak frequency of the differential waveform falls within a range defined by frequency thresholds.

17. The diagnostic method according to claim 16, comprising:
using a difference between a peak frequency of the start-up waveform and a peak frequency of the initial waveform as a correction value used for correcting the thresholds.

18. The diagnostic method according to claim 17, comprising:
adding the correction value to the frequency thresholds; and
determining whether the production material has been processed normally using the frequency thresholds to which the correction value has been added.

19. The non-transient computer readable medium storing a program, according to claim 14, to perform processing for:
determining whether the production material has been processed normally, based on a differential waveform obtained from a difference between the operation waveform and the start-up waveform.

20. The non-transient computer readable medium storing a program, according to claim 19, to perform processing for:
determining whether the production material has been processed normally, based on whether a peak frequency of the differential waveform falls within a range defined by frequency thresholds.

21. The non-transient computer readable medium storing a program, according to claim 20, to perform processing for:
using a difference between a peak frequency of the start-up waveform and a peak frequency of the initial waveform as a correction value used for correcting the thresholds.
